(19) United States
(12) Patent Application Publication
(10) Pub. No.: US 2009/0014460 A1
(43) Pub. Date: Jan. 15, 2009

(54) MOBILE SELF-CONTAINED POWER VENDING STATION AND METHOD

(76) Inventors: Joseph M. Kobus, II, Stockbridge, MI (US); Michael J. Ruedisueli, Charlotte, MI (US)

Correspondence Address: PAPARELLA & ASSOCIATES, PLC, 3878 CASCADE RD. SE, GRAND RAPIDS, MI, 49546, US

(21) Appl. No.: 11/776,596

(22) Filed: Jul. 12, 2007

(51) Int. Cl. G07F 15/00

(52) U.S. Cl. 221/135

(57) ABSTRACT

A system for charging a power source of an electronic device includes a mobile self-contained power vending station that includes a central processor, a payment processing device, a DC power source, a DC to AC power inverter, and an AC outlet. The central processor, after detecting a valid payment from the payment processing device activates the DC to AC power Inverter thereby providing electricity to the power source of the electronic device via the AC outlet.

### BACKGROUND OF THE INVENTION

The present invention relates to a vending station, and more specifically to a power vending station for recharging power sources of electronic devices.

The telecommunications industry has made great strides in commercial operations in the United States as well as the rest of the world. In this modern era of communications, individuals and the companies they work for are increasingly dependent on a variety of electronic devices to receive and send information. This dependency has resulted in a large number of battery-operated devices, such as: portable “laptop” computers, cellular phones, pagers, personal digital assistants (PDAs), and the like, that allow an individual to stay in touch and accomplish work tasks while traveling.

In the course of their jobs, traveling professionals often spend significant amounts of time in airports, train stations, hotel lobbies, as well as various other public and semi-public areas. For the vast numbers of workers who rely on their portable electronic devices while abroad, an undercharged laptop computer or PDA can cause all manner of inconveniences and loss of productivity. Innovative solutions are required to meet these increasing needs and to maintain high quality service.

One of the greatest challenges associated with the continuing development of laptop computers, cellular phones, and other electronic devices, involve providing an adequate power supply in a small package. A battery pack is typically the main power source for these, and other, portable electronic devices, e.g., portable computers and cellular phones. While larger batteries give more power, there remains a conflict between a desire for longer usage periods and the desire for smaller, lighter designs. Similarly, consumers demand new designs for other portable electronic devices to be lighter and smaller, often limiting the size and capacity of the included batteries.

Despite the advent of batteries with increased energy-to-weight ratios, such as the currently popular lithium ion battery, battery life is still a major limitation to the use of portable electronic devices. To overcome this limitation, many of these devices can operate on and recharge from an AC power source. However, AC power for this purpose is not readily available in most public and semi-public places including airports, bus terminals, convention centers and restaurants. Even where AC power is available, the availability of AC outlets is scarce and they are often set in inconvenient places.

Some electronic device users carry spare, fully charged, batteries whenever they expect to be away from wired communications for an extended period. Having a spare battery pack could resolve the insufficient power dilemma, but the cost of purchasing an additional battery pack may be prohibitive. And, despite the seeming simplicity of this solution, many users may often find themselves with a discharged, or “dead”, battery pack. In the more frustrating case, the user may have not planned adequately, and will have forgotten to bring a spare battery pack.

With a large percentage of the population carrying and actively depending on electronic devices with battery power sources, there is an increasing demand for advanced solutions and associated technologies. A solution to this dilemma involves convenient access to a power vending station that provides consistent and reliable recharging of the power source of electronic devices. Furthermore, a power vending station that is both mobile and self-contained would allow widespread and convenient placement of these vending stations.

Accordingly, a need exists for novel systems and methods that have, among other advantages, the ability to provide convenient and consistent access to electricity in public places, while simultaneously being mobile and self-contained. Therefore, a mobile self-contained power vending station and method that solves the aforementioned disadvantages and having the aforementioned advantages is desired.

### SUMMARY OF THE PRESENT INVENTION

The aforementioned drawbacks and disadvantages of electronic devices with limited battery power have been identified and a solution is set forth herein by the inventive system for charging a power source of an electronic device wherein the system comprises a mobile self-contained power vending station including a central processor, a payment processing device, a DC power source, a DC to AC power inverter, and an AC outlet. Wherein, upon detecting a valid payment from the payment processing device, the central processor activates the DC to AC inverter, thereby providing electricity to a power source of an electronic device via the AC outlet.

Another aspect of the present invention includes a system for charging a power source of an electronic device wherein the system comprises a mobile self-contained power vending station including a central processor, a payment processing device, a wireless communications device, a DC power source, a state-of-charge sensor, a usage detection sensor, a DC to AC power inverter, an AC outlet and a user interface. The system also comprises a central data station. Wherein, upon detecting a valid payment from the payment processing device and upon detecting, via the usage detection sensor, a power source of an electronic device is connected to the AC outlet, the central processor activates the DC to AC power inverter thereby providing electricity to a power source of an electronic device via the AC outlet. Further, wherein upon detecting, via the state-of-charge sensor, a lesser state-of-charge level of the DC power source than a predetermined state-of-charge level, the central processor activates the wireless communications device in order to transmit a notification to the central data station.

In another aspect of the present invention, a method for charging a power source of an electronic device, wherein the method comprises providing a mobile self-contained power vending station including a central processor, a payment processing device, a notification apparatus, a DC power source, a state-of-charge-sensor, a usage detection sensor, a DC to AC power inverter, an AC outlet and a user interface. The method also comprises providing a central data station, detecting a lesser state-of-charge level of the DC power source than a predetermined state-of-charge level, disabling the payment processing device upon detection of a lesser state-of charge level of the DC power source than the predetermined state-of charge level and finally notifying the central data station of the lesser state-of-charge level via the notification apparatus.

And still in another aspect of the present invention, a method for charging a power source of an electronic device, wherein the method comprises providing a mobile self-contained power vending station including a central processor, a payment processing device, a wireless communications device, a DC power source, a state-of-charge-sensor, a usage detection sensor, a DC to AC power inverter, at least one GFCI outlet, and a user interface. The method also comprises providing a central data station, determining a higher state-of-charge level of the DC power source than a predetermined state-of-charge level, accepting payment from a user, determining validity of payment, determining a charging time period, displaying instructions on the user interface for the user to select the at least one GFCI outlet, displaying instructions on the user interface for the user to connect a power source of an electronic device to the at least one GFCI outlet, detecting the power source of the electronic device is connected to the at least one GFCI outlet, activating the DC to AC power inverter, displaying the charging time period on the user interface, activating the at least one GFCI outlet for the duration of the charging time period, displaying the remaining charging time period on the user interface, determining power consumption of the electronic device, displaying instructions on the user interface for the user to insert additional payment, deactivating the at least one GFCI outlet at the end of the charging time period, deactivating the DC to AC power inverter, and finally, displaying a notice on the user interface signifying a complete charging period.

Other objects, advantages, and features of the invention will become apparent upon consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. To wit, the mobile self-contained power vending station and methods of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U.S. Patent and Trademark Office and the public generally, and especially the scientists, engineers, and practioners in the art who are not familiar with the patent or legal terms of phraseology, to learn quickly, from a cursory inspection, the nature of the technical disclosure of the application. Accordingly, the Abstract is intended to define neither the invention nor the application, which is only measured by the claims, nor is it intended to be limiting as to the scope of the invention in any way.

These and other objects, along with the various features, and structures that characterize the invention, are pointed out with particularity in the claims annexed to and forming a part of this disclosure. For a better understanding of the mobile self-contained power vending station and method of the present disclosure, its advantages, and the specific objects attained by its uses, reference should be made to the accompanying drawings and descriptive matter in which there are illustrated and described the preferred embodiments of the invention.

As such, while embodiments of the mobile self-contained power vending station are herein illustrated and described, it is to be appreciated that various changes, rearrangements and modifications may be made therein, without departing from the scope of the invention as defined by the claims.

### BRIEF DESCRIPTION OF THE DRAWINGS

As a compliment to the description and for better understanding of the specification presented herein, six pages of drawings are disclosed with an informative, but not limiting, intention.

FIG. 1 is a block diagram of an embodiment of the present invention;

FIG. 2 is a block diagram of another embodiment of the present invention;

FIG. 3 front view of a mobile self-contained power vending station based upon the vending station of FIG. 1;

FIG. 4 is a schematic flow chart illustrating a method according to the invention;

FIG. 5 is another schematic flow chart illustrating a method according to another embodiment of the present invention;

FIG. 6 is yet another schematic flow chart illustrating a method according to another embodiment of the present invention.

### DETAILED DESCRIPTION OF THE PREFERRED EMBODIMENT

The best mode for carrying out the invention is presented in terms of the preferred embodiment, wherein similar referenced characters designate corresponding features throughout the several figures of the drawings.

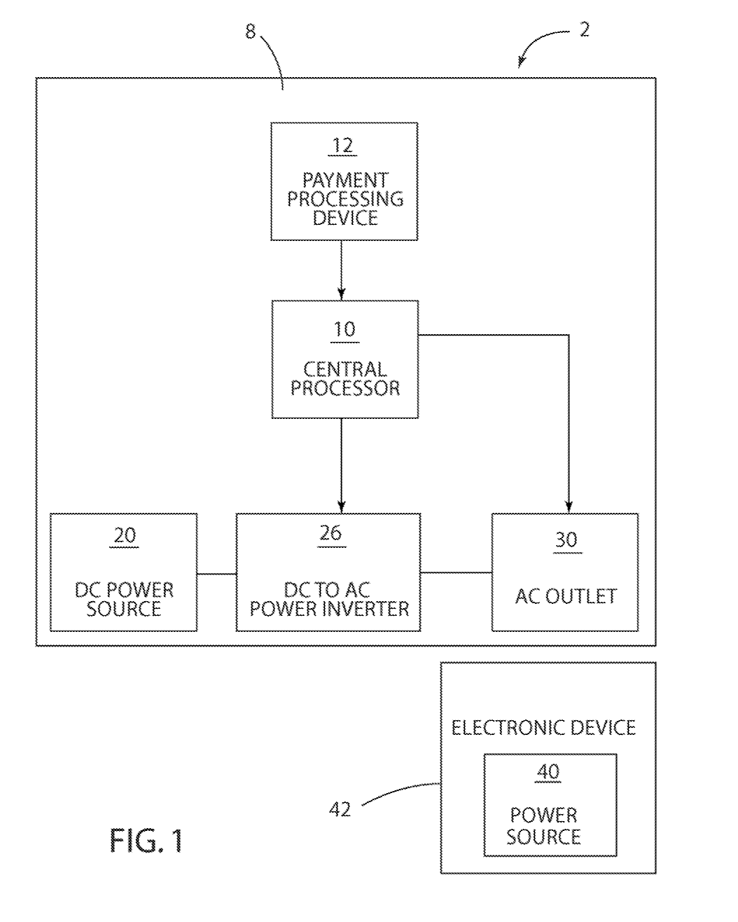

For purposes of description herein, the terms “upper”, “lower”, “right”, “left”, “rear”, “front”, “vertical”, “horizontal”, and derivatives thereof, shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. Like features between the various embodiments utilize similar numerical designations. Where appropriate, the various similar features have been further differentiated by an alphanumeric designation, wherein the corresponding alphabetic designator has been changed. Further, the dimensions illustrated in the drawings (if provided) are included for purposes of example only and are not intended to limit the scope of the present invention. Additionally, particular details in the drawings which are illustrated in hidden or dashed lines are to be considered as forming no part of the present invention.

As used herein, the term “mobile” is meant to be used and defined in its general and ordinary sense. Namely, mobile generally describes an object capable of moving or of being moved readily from place to place by an individual person without the assistance of others. To wit, a mobile apparatus is one that requires no assembly or disassembly in order to be placed or positioned in various locations. For example, a mobile power vending station in need of service can be picked up by and individual service person and placed on/off a service cart or in/out of a vehicle. Of course, this is not meant to be limiting in any manner. Rather, the mobile nature of the invention may lake on numerous configurations and may be used for numerous purposes as is generally known within the art.

As used herein, the term “self-contained” is meant to be used and defined in its general and ordinary sense. To wit, self-contained generally describes an object that is a complete and independent unit in and of itself. In one example, a self-contained machine is one having all the essential working pans contained in a case so that mutual relations of the parts are independent from components outside of the machine itself. While the power vending station of the present invention is mobile and self-contained, the vending station may utilize locking devices, such as chains, cables, padlocks, etc., to secure the station from theft or unauthorized removal. Locking devices are an additional security feature, and do not deprive the power vending station of its self-contained nature. Of course, this is not meant to be limiting in any manner. Rather, the self-contained nature of the invention may take on numerous configurations, and may be used for numerous purposes as is generally known within the art.

As used herein, the term “state-of-charge” is meant to be used and defined in its general and ordinary sense. To wit, state-of-charge generally refers to the ratio of residual capacity at a given instant with respect to the maximum capacity available from a battery. That is to say, that the state-of-charge of a battery is its remaining energy expressed in relation to its capacity when full. Of course, this is not meant to be limiting in any manner and the state-of charge of batteries may take on numerous configurations, and may be used for numerous purposes as is generally known within the art.

As used herein, the term “notification” is meant to be used and defined in its general and ordinary sense. To wit, notification generally refers an indicator of the current status of a device. For example, the central processor of a power vending station may transmit a notification, or notice, to a central data station, via a communications device, indicating the power vending station's power source has a minimal state-of-charge and is in need of replacement. Of course, this is not meant to be limiting in any manner and notifications may take on numerous configurations, and may be used for numerous purposes as is generally known within the art.

In the course of their jobs, traveling professionals often spend significant amounts of time in airports, train stations, hotel lobbies, as well as various other public and semi-public areas. For the vast numbers of workers who rely on their portable electronic devices while abroad, an undercharged laptop computer or PDA can cause all manner of inconveniences and loss of productivity. Innovative solutions are required to meet these increasing needs and to maintain high quality service.

One of the greatest challenges associated with the continuing development of laptop computers, cellular phones, and other electronic devices, involve providing an adequate power supply in a small package. A battery pack is typically the main power source for these, and other, portable electronic devices, e.g., portable computers and cellular phones. While larger batteries give more power, there remains a conflict between a desire for longer usage periods and the desire for smaller, lighter designs. Similarly, consumers demand new designs for other portable electronic devices to be lighter and smaller, often limiting the size and capacity of the included batteries.

Despite the advent of batteries with increased energy-to-weight ratios, such as the currently popular lithium ion battery, battery life is still a major limitation to the use of portable electronic devices. To overcome this limitation, many of these devices can operate on and recharge from an AC power source. However, AC power for this purpose is not readily available in most public and semi-public places including airports, bus terminals, convention centers and restaurants. Even where AC power is available, the availability of AC outlets is scarce and they are often set in inconvenient places.

Some electronic device users carry spare, fully charged, batteries whenever they expect to be away from wired communications for an extended period. Having a spare battery pack could resolve the insufficient power dilemma, but the cost of purchasing an additional battery pack may be prohibitive. And, despite the seeming simplicity of this solution, many users may often find themselves with a discharged, or “dead”, battery pack. In the more frustrating case, the user may have not planned adequately, and will have forgotten to bring a spare battery pack.

With a large percentage of the population carrying and actively depending on electronic devices with battery power sources, there is an increasing demand for advanced solutions and associated technologies. A solution to this dilemma involves convenient access to a power vending station that provides consistent and reliable recharging of the power source of electronic devices. Furthermore, a power vending station that is both mobile and self-contained would allow widespread and convenient placement of these vending stations.

Accordingly, a need exists for power vending stations, which have, among other advantages, the ability to provide convenient and consistent access to electricity in public places, and which are mobile and self-contained. Therefore, a power vending machine and method that solves the aforementioned disadvantages and having the aforementioned advantages is disclosed herein.

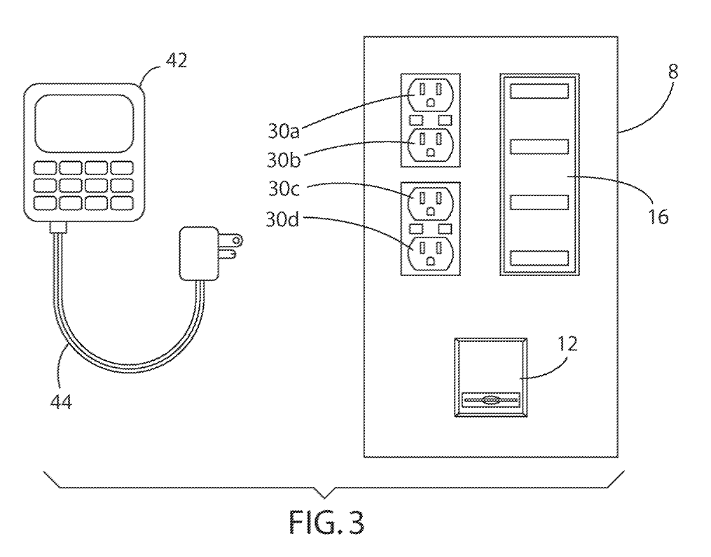

The disadvantages and drawbacks of the prior art are overcome through the mobile self-contained power vending station and methods of the present invention, wherein one preferred embodiment is disclosed in FIGS. 1 and 3. Referring now to FIG. 1, there is shown a block diagram of a system 2 for charging a power source 40 of an electronic device 42. System 2 comprises a mobile self-contained power vending station (herein referred to as “MSCP vending station”) 8. MSCP vending station 8 includes a central processor 10, a payment processing device 12, a DC power source 20, a DC to AC power inverter 26, and an AC outlet 30. Central processor 10, after detecting a valid payment activates DC to AC power inverter 26 thereby providing electricity to power source 40 of electronic device 42.

Power source 40 generally refers to a rechargeable battery type known in the art that is suitable for powering electronic device 42. Typical examples include lithium ion batteries, nickel-metal hydride batteries and nickel-cadmium batteries. Of course, this is not meant to be limiting in any manner and power source 40 may take on numerous configurations, and may be used for numerous purposes as is generally known within the art.

Electronic device 42 generally refers to any portable device utilizing a power source 40. Typical examples include cellular phones, pagers, portable computers, personal digital assistants (PDAs), music players, cameras, portable gaining systems, and the like. Of course, this is not meant to be limiting in any manner and electronic device 40 may take on numerous configurations, and may be used for numerous purposes as is generally known within the art.

Central processor 10 generally refers to a device that interprets program instructions and performs operations on data. For instance, the central processor of a computer directs data, to and from other devices in the computer system, such as the computer's memory and input devices. In the present invention, central processor 10 may comprise a device that directs data and the operation of the other components in MSCP vending station 8. Of course, this is not meant to be limiting in any manner and central processor 10 may take on numerous configurations, and may be used for numerous purposes as is generally known within the art.

Payment processing device 12 generally refers to a device that will accept paper or coinage currency and/or will read the information on a credit-type card. In the present invention, payment processing device 12 may comprise any bill acceptor, coin acceptor. card reader, coupon acceptor, or combination thereof that is known in the art. Central processor detects if payment processing device 12 has accepted a valid payment. Valid payment generally refers to genuine currency that is issued by a government and circulated within an economy. Payment processing device 12 may accept currency from some or many governments. For example, payment processing device 12 may accept U.S. dollars, Canadian dollars, European Union Euros, and the like. Of course, coinage may be accepted as valid currency as well. On the occasion that a credit card, debit card, or some other form of payment is used that requires validation of available funds, central processor 10 may enables wireless communications device 18 to communicate the information to central data station 6 for validation. Other examples of payment that may be accepted in other embodiments include: gift cards, pre-paid cards, membership cards, and voucher slips/coupons. Accepting multiple forms of payment may further encourage widespread commercial use as well as corporate sponsorships of the present invention. Of course, this is not meant to be limiting in any manner and payment processing device 12 may take on numerous configurations, and may be used for numerous purposes as is generally known within the art.

DC power source 20 comprises any battery type known in the art that is suitable to the present invention. Some examples of battery types include: lead acid batteries, nickel-cadmium batteries, nickel-metal hydride batteries, valve-regulated or recombinant lead acid batteries (including gel cell batteries, and absorbed glass mat batteries), lithium ion batteries, super capacitor batteries, and fuel cell batteries. Of course, this is not meant to be limiting in any manner and DC power source 20 may take on numerous configurations and may be used for numerous purposes as is generally known within the art.

DC to AC power inverter 26 comprises a device used to convert direct current (DC) into alternating current (AC). For example, DC electricity from DC power source 20 may be converted by DC to AC power inverter 26 into 110V or 220V AC electricity. To clarify, the standard of 110V or 220V AC electricity is generally understood by those within the art to encompass a range of acceptable voltages. In the example of “110V”, the actual voltage provided may range from 110V to 120V, depending on such factors as, the resistive voltage drops in the wiring and the like. Most electronic devices are designed to cope with the variance in voltage. Of course, this is not meant to be limiting in any manner and AC to DC power inverter 26 may lake on numerous configurations and may be used for numerous purposes as is generally known within the art.

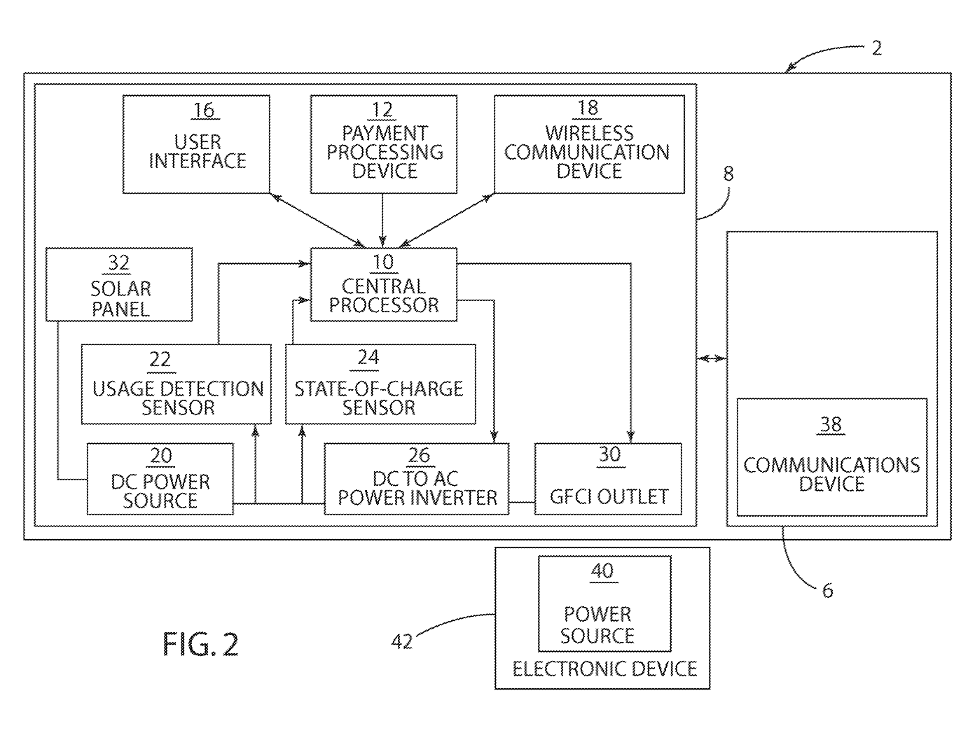

AC outlet 30 generally refers to a receptacle providing a place in a wiring system from where alternating current can be taken to run electrical devices. As shown, in FIG. 2, AC outlet 30 may comprise a ground-fault circuit interrupter (herein referred to as GFCI outlet 30). GFCI outlets are also AC outlets that contain an electrical wiring device that disconnects a circuit whenever it detects that the flow of current is not balanced between the phase (“hot”) conductor and the neutral conductor. The presumption is that such an imbalance may represent current leakage through the body of a person who is grounded and accidentally touching the energized part of the circuit. A shock, possibly lethal, is likely to result from these conditions; GFCI outlets are designed to disconnect quickly enough to prevent such shocks. In one embodiment of the present invention, as shown in FIG. 3, MSCP vending station 8 comprises one or more. GFCI outlets 30 (GFCI outlets 30a, 30b, 30c, 30d). Of course, this is not meant to be limiting in any manner and AC outlet 30, including GFCI outlet 30, may take on numerous configurations and may be used for numerous purposes as is generally known within the art.

An adapter cord 44 suitable for connecting power source 40 of electronic device 42 to AC outlet 30 is typically provided by the user. Adapter cord 44, as shown in FIG. 1, generally refers to a device used to match the physical or electrical characteristics of two different components so that a connection may be made between them. In one example, adapter cord 44 may be a device that adapts electrical current from a high voltage of 110 VAC from AC outlet 30 to a low voltage of 3V DC to 24V DC suitable for charging many electronic devices 42. Of course, this is not meant to be limiting in any manner and adapter cord 44 may take on numerous configurations and may be used for numerous purposes as is generally known within the art.

In another embodiment, as shown in FIG. 2, mobile self-contained vending station 8 further includes a state-of-charge sensor 24, a notification apparatus 18, and a usage detection sensor 22, and a user interface 18. AC outlet 30 also comprises a GFCI outlet 30. Also, system 2 furthers comprise a central data station 6.

In the present invention, state-of-charge sensor 24 determines the ratio of residual capacity at a given instant with respect to the maximum capacity available from a DC power source 20. Monitoring the amount of energy left in DC power source 20 compared with the energy it had when it was initially charged gives an indication of how much longer a DC power source 20 will continue to perform before recharging becomes necessary. State-of-charge can be determined by various methods known in the art. For example only, the state-of-charge of a DC power source 20 can typically be measured by voltage, specific gravity, or current. A predetermined state-of-charge level is a set state-of-charge level wherein the DC power source should be recharged. Depending on the type of DC power source 20, the predetermined state-of-charge level may vary according to manufacturer's specifications. For example, MSCP vending station 8, including a nickel metal hydride battery may have a predetermined state-of-charge level of 20%. Continuing the example, upon detection of a lesser state-of-charge level than 20%, central processor 10 deactivates payment processing device 12, and in one particular embodiment, activates notification apparatus 18. Deactivating payment processor device 12 serves to prevent further discharge of DC power source 20 before recharging is possible. Additionally, deactivating payment processing device 12 prevents the next user from making a payment and expecting power. In other embodiments, other components, such as user interface 16, may be deactivated to conserve power of DC power source 20. In the case where MSCP vending station 8 has already accepted payment and has initiated the charging of power source 40 of electronic device 42 when a lesser state-of-charge level than the predetermined state-of-charge level is detected, MSCP vending station 8 will complete the current charging time period before deactivating any components. Of course, this is not meant to be limiting in any manner and state-of charge sensor 24 may take on numerous configurations and may be used for numerous purposes as is generally known within the art.

Notification apparatus 18 is utilized by central processor 10, to notify or signal the lesser state-of-charge level than a predetermined state-of-charge level. In one embodiment, notification apparatus may comprise an LED light and/or a sound device that emits a distinctive tone or beep. For example, upon detection of a lesser state-of-charge level than a predetermined state-of-charge level, central processor 10 may activate a flashing light, indicating that DC power source 20 of MSCP vending station 8 requires recharging.

In another embodiment of the present invention, notification apparatus 18 may comprise wireless communications device 18. Wireless communications device 18 generally refers to a wireless device, such as a wireless router, that forwards information from one computer to another. In other examples, wireless communications device 18 may be a transmitter of radio waves, telephone signals, other telecommunication signals and the like. Wireless communications device 18, in one embodiment, allows MSCP vending station 8 to communicate information to and from central data station 6. For example, credit card information entered into payment processing device 12 of MSCP vending station 8 may be transmitted to central data station 6, which performs a payment validation process. Furthermore, other information, such as power status, may be communicated to central data station 6.

Continuing on, upon detecting a lesser state-of-charge level of DC power source 20 than a predetermined state-of-charge level, central processor 10 activates wireless communications device 18 in order to notify central data station 6 of the lesser state-of-charge level. Upon notification, MSCP vending station 8 is replaced with a second MSCP vending station 8 including a DC power source 20 comprising a higher state-of-charge level than the predetermined state-of-charge level. In an alternate embodiment, upon detecting a lesser state-of-charge level of DC power source 20 than the predetermined state-of-charge level, MSCP vending station 8 may remain in place, while DC power source 20 is replaced with a second DC power source 20 comprising a higher state-of-charge level than the predetermined state-of-charge level. Servicing and/or replacement may be carried out by an authorized service person as notifications are received, as well as on a routine maintenance schedule regardless of notifications. Of course, this is not meant to be limiting in any manner and wireless communications device 18 may take on numerous configurations, and may be used for numerous purposes as is generally known within the art.

Usage detection sensor 22 determines multiple aspects of the mobile power vending station 8. In one embodiment, central processor 10 queries usage detection sensor 22 to detect if power source 40 of an electronic device 42 has been connected to AC outlet 30 (or GFCI outlet 30). If a connection is detected, central processor 10 proceeds to activate DC to AC power inverter 26. Once charging of electronic device 42 has commenced, central processor 10 may also detect, via usage detection sensor 10, the power consumption by electronic device 42. In detecting power consumption, if the measured current is less than a maximum predetermined current value (as determined by MSCP vending station 8's design and components), MSCP vending station 8 continues to provide electricity. If the measured current is greater than a maximum predetermined current value, central processor 10 deactivates AC outlet 30, and pauses the lapse of the charging time period. In such a case, power source 40 of electronic device 42 is considered to be an “unapproved” power source 40 of electronic device 42. For example, central processor 10 detects, via usage detection sensor 22, an “unapproved” power source 40 of electronic device 42 (such as a hair blow dryer) is drawing more than a maximum predetermined current value of 2 Amps (Amperes). Upon detection, AC outlet 30 is deactivated, and the charging time period is paused. Instructions may be displayed on user interface 16 to disconnect “unapproved” power source 40 of electronic device 42 and to connect to a power source 40 of an electronic device 42 that consumes power at a rate less than the maximum predetermined current value (i.e. “approved”). If “approved” power source 40 of electronic device 42 is connected, central processor 10 re-actives AC outlet 30 and resumes the charging time period. In the case where a power source 40 of electronic device 42 is detected as consuming more than a maximum predetermined current value, deactivating AC outlet 30 prevents excessive discharge of power from DC power source 20 and prevents damage to the components of MSCP vending station 8.

Furthermore, usage detection sensor 22 also detects the disconnection of power source 40 of electronic device 42 from AC outlet 30. If a disconnection is detected, instructions to reconnect power source 40 of electronic device 42 may be displayed on user interface 16. Central processor 10 may allot a time period of, for example, two minutes for power source 40 of electronic device 42 to be reconnected. If power source 40 is not reconnected within the allotted time period central processor 10 will deactivate AC outlet 30 and remove any remaining charging time period displayed on user interface 16. An end of charging message may be displayed on user interface 16 signifying that the charging period has terminated.

User interface 16 comprises a display screen that presents visual information. A charging time period, such as a timer display, may be displayed. User interface 16 may also display instructions, advertisements, and the like. In addition, user interface 16 may comprise buttons, tabs, a touch screen or some son of selection apparatus for choosing at least one GFCI outlet 30, where there are multiple GFCI outlets 30 available, as shown in FIG. 3. Of course, this is not meant to be limiting in any manner and user interface 16 may take on numerous configurations, and may be used for numerous purposes as is generally known within the art.

Usage detection sensor 22 determines multiple aspects of the MSCP vending station 8. In one embodiment central processor 10 queries usage detection sensor 22 to determine if power source 40 of an electronic device 42 has been connected to AC outlet 30. If a connection is detected, central processor 10 proceeds to activate DC to AC power inverter 26. Once charging of electronic device 42 has commenced, usage detection sensor 22 may also detect the power consumption by electronic device 42. If the measured current is less than a maximum current value determined by MSCP vending station 8's design, MSCP vending station 8 continues to provide electricity. If the measured current is greater than a maximum current value, central processor 10 deactivates AC outlet 30, and pauses the lapse of the charging time period. Instructions may be displayed on user interface 16 to disconnect the unapproved power source 40 of electronic device 42 and to connect to approved power source 40 of electronic device 42 that consumes less than the maximum current value. If approved power source 40 of electronic device 42 is connected, central processor 10 re-actives AC outlet 30 and resumes the charging time period.

Furthermore, usage detection sensor 22 also detects the disconnection of power source 40 of electronic device 42 from AC outlet 30. If a disconnection is detected, instructions to reconnect power source 40 of electronic device 42 may be displayed on user interface 16. Central processor 10 may allot a time period of, for example, two minutes for power source 40 of electronic device 42 to be reconnected. If power source 40 is not reconnected within the allotted time period central processor 10 will deactivate AC outlet 30 and remove any remaining charging time period displayed on user interface 16. An end of charging message may be displayed on user interface 16 to notify the user that the charging process has terminated.

For the purposes of the present invention, central data station 6 generally refers to a computer system or processing apparatus and an electronic database. Central data station 6 including a communications device 38 is capable of communicating with other devices and apparatus that are also equipped with a communications device. As central data station 6 is not utilized by users for recharging electronic devices, central data station 6 may be located remotely from MSCP vending station 8, and may therefore be powered by battery, by a traditional AC power outlet, or any other manner of power known in the art. Communications device 38 may also be hardwired or wirelessly connected to a communications network, such as the Internet, a land-based telephone network, a conventional LAN network environment, or any other suitable network. Of course, this is not meant to be limiting in any manner and communications device 38 may take on numerous configurations, and may be used for numerous purposes as is generally known in within the art.

Furthermore, central data station 6 may also be capable of multiple tasks. One example includes querying MSCP vending station 8 for system level statistics such as: the state-of-charge of DC power source 20, the number of usage sessions, the average device current consumption, the amount of currency received and contained by payment processing device 12, and the like. Central data station 6 may also be capable of communicating information to MSCP vending station 8, such as messages to be displayed on user interface 16. Of course, this is not meant to be limiting in any manner and central data station 6 may take oil numerous configurations, and may be used for numerous purposes as is generally known within the art.

MSCP vending station 8, in another embodiment, may further comprise a solar panel 32. Solar panel 32 generally refers to a device that collects and converts solar energy into electricity or heat. For example, solar panel 32 may be a photovoltaic module, a package of interconnected assembly of photovoltaic cells, which convert light into electrical power. Solar panel 32 may supplement the state-of-charge level of DC power source 20, when MSCP vending station 8 is in a sunny or well-lit environment, thus giving the MSCP vending station 8 a longer period before servicing is required. Of course, this is not meant to be limiting in any manner and solar panel 32 may take on numerous configurations and may be used for numerous purposes as is generally known within the art.

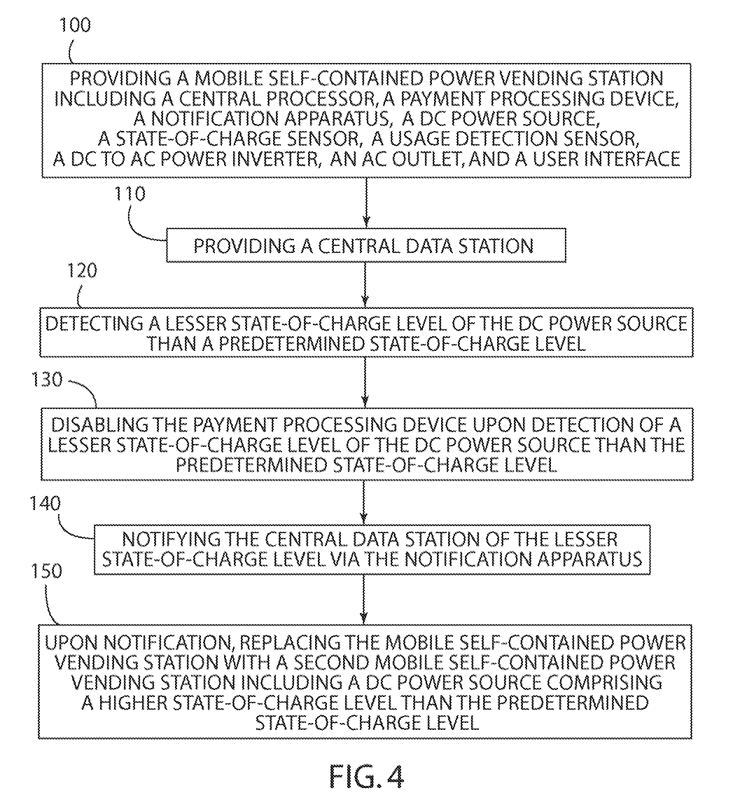

Referring now to FIG. 4, one embodiment of the inventive method for charging power source 40 of electronic device 42 comprises providing MSCP vending station 8 Including: central processor 10, payment processing device 12, notification apparatus 18, DC power source 20, state-of-charge sensor 24, usage detection sensor 22, DC to AC power inverter 26, AC outlet 30 and user Interface (step 100) and providing central data station 6 (step 110). Upon detecting a lesser state-of-charge level of DC power source 20 than a predetermined state-of-charge level (step 120), central processor 10 disables payment processing device 12 (step 130), and notifies central data station 6 of the lesser state-of-charge level via notification apparatus 18 (step 140).

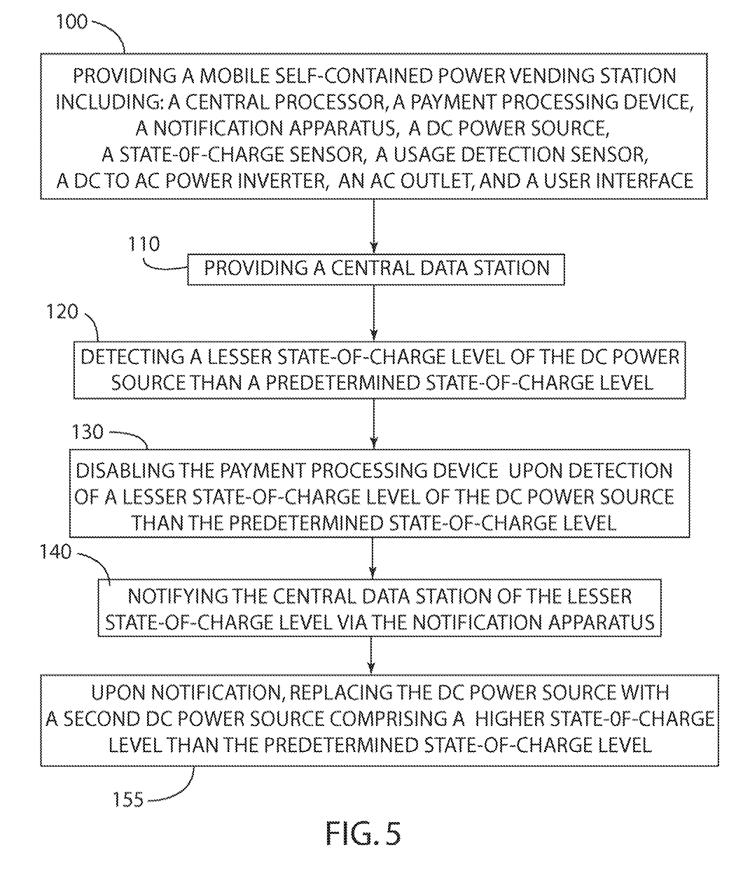

Other embodiments of the inventive method may include additional steps. As shown in FIG. 4, another embodiment of the method may further comprise, upon notification, replacing MSCP vending station 8 with a second MSCP vending station 8 including a DC power source 20 comprising a higher than state-of-charge level than the predetermined state-of-charge level (step 150). As shown in FIG. 5, in another embodiment, the inventive method may alternatively comprise replacing DC power source 20 with a second DC power source 20 comprising a higher than state-of charge level than the predetermined state-of-charge level, (step 155), rather than replacing MSCP vending station 8 entirely.

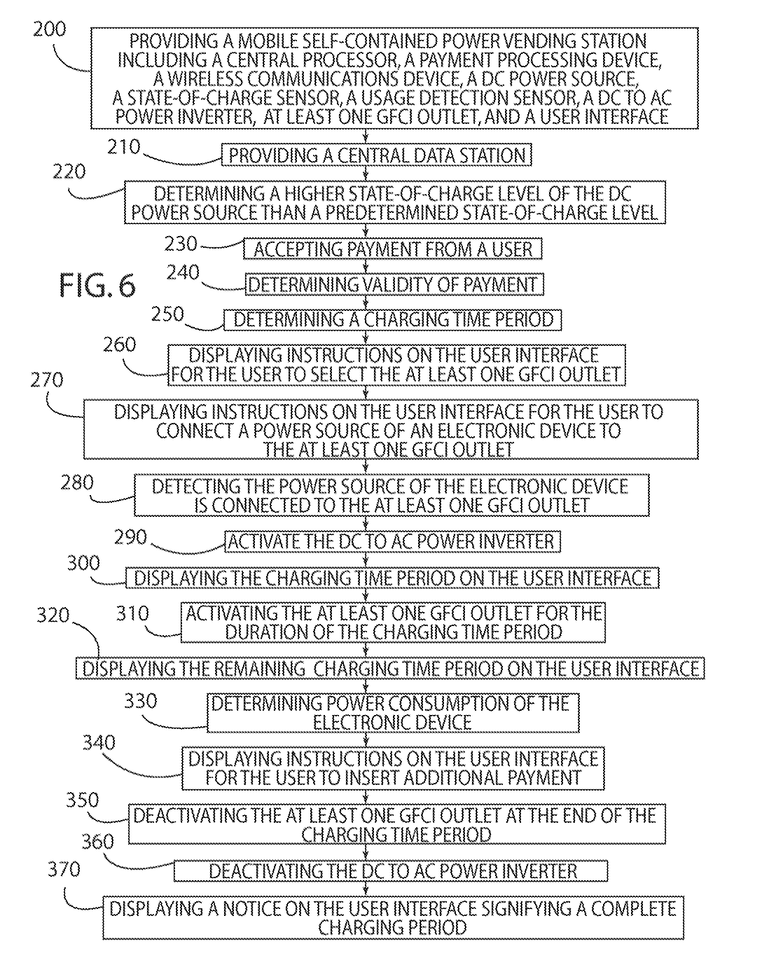

Referring now to FIG. 6, one embodiment of the inventive method, the method comprises providing MSCP vending station 8 including: central processor 10, payment processing device 12, wireless communications device 18. DC power source 20, state-of-charge sensor 24, usage detection sensor 22, DC to AC power inverter 26, at least one GFCI outlet 30, and solar panel 32 (step 200). The method also provides a central data station 6 (step 210).

Continuing on, central processor 10 determines a higher state-of-charge level of DC power source 20 than a predetermined state-of-charge level (step 220). This determination may be performed periodically to ensure MSCP vending station 8 is capable of providing a reliable and consistent source of electricity and to avoid excessive degradation of DC power source 20 that may occur with allowing the state-of-charge level to drop lower than the predetermined state-of-charge level.

Payment is accepted from a user (step 230) when a user places currency or a credit or debit-type card into payment processing device 12 and the payment is then validated (step 240). Typically when currency is accepted, payment processing device 12 determines the validity of the payment. In the case where a credit or debit-type card is accepted, determining payment validity may be carried out by central data station 6. Central processor 10 of MSCP vending station 8 enables wireless communications device 18 to transmit the credit information to central data station 6. Central data station 6 may connect, via communications device 38, to a payment validation service. Of course, the method of determining payment validity is not limited in any manner and may be carried out in any manner generally known within the art.

Once payment has been validated, central processor 10 determines a charging time period 34 (step 250), based on the amount of payment provided by the user. The determined charging time period increment may be based on the typical power source of common electronic devices and the amount of power needed to charge power source 40 of electronic device 42 sufficiently to allow continued use of electronic device 42. In one example only, one dollar may purchase 20 minutes of electricity. Of course, this is not meant to be limiting in any manner and determined time period 34 may take on numerous configurations and may be used for numerous purposes as is generally known within the art.

Continuing on, central processor 10 displays instructions for the user to select at least one GFCI outlet 30 on user interface 16 (step 260). User interface 16 may comprise buttons, labs, a touch screen or some other selection apparatus for selecting the at least one GFCI outlet 30. Of course, this is not meant to be limiting in any manner and user interface 16 may take on numerous configurations and may be used for numerous purposes as is generally known within the art. Next, central processor 10 displays instructions for the user to connect power source 40 of electronic device 42 to the at least one GFCI outlet 30 (step 270). Central processor 10, via usage detection sensor 22, determines power source 40 of electronic device 42 is connected to the at least one GFCI outlet 30 (step 280). Once a connection is determined, central processor 10 activates DC to AC power inverter 26 (step 290), and displays charging time period 34 on user interface 16 (step 300). Central processor 10 also activates the at least one GFCI outlet 30 for the duration of charging time period 34 (step 310). As charging of power source 40 of electronic device 42 continues, central processor 10 displays the remaining charging time period 34 on user interface 16 (step 320).

To prevent excessive current draw from the connection of an unapproved electronic device 42 with a power source 40 not adapted to be charged by MSCP vending station 8, central processor 10, utilizing usage detection sensor 22, determines the power consumption of power source 40 of electronic device 42 (step 330).

During the charging process, central processor 10 displays instructions, on user interface 16, for the user to insert additional payment (step 340) for an additional charging time period 34. For example only, two minutes before charging time period 34 has ended, instructions for the user to insert additional payment may be displayed. Additional payment will increase charging time period 34.

At the end of charging time period 34, central processor 10 deactivates the selected GFCI outlet 30 (step 350), deactivates DC to AC power inverter 26 (step 360) and finally displays a notice on user interface 16 signifying a complete charging period (step 370). The user is now free to disconnect power source 40 of electronic 42 from GFCI outlet 30 and to enjoy the charged electronic device 42.

While one preferred embodiment has been described, the specific characteristics of MSCP vending station 8 and central station 6 may vary according to the specific requirements of the end user. Further, MSCP vending station 8 accomplishes many of the movement and actions herein described, simultaneously, as such, the system and method, do not necessarily have a linear sequence of events. Therefore, the system will be described by reference to the various stations and the actions performed. It is also to be understood that various modifications may be made the machine, its sequences, methods, orientations, and the like without departing from the inventive concept and that the description contained herein is merely one of multiple embodiments and hence, not meant to be limiting unless stated otherwise.

Advantageously, the mobile self-contained power vending station of the present invention is efficiently fabricated and elegantly designed while being engineered to be mobile and self-contained. Consequently, the embodiments of the preferred invention disclosed herein reveal a mobile self-contained power vending station which has been reduced in size and bulk, is fully mobile compared to existing designs, and can therefore be easily serviced and/or replaced. Additionally, the mobile, self-contained power vending station of the present invention is consistently and reliably powered.

The solutions offered by the invention disclosed herein have thus been attained in an economical, practical, and facile manner. To whit, a novel system and methods of charging a power source of an electronic device which is cost effective, mobile, easily serviced, and provides consistent and reliable power has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

The invention claimed is:

1. A system for charging a power source of an electronic device, the system comprising:
a mobile self-contained power vending station including:
a central processor;
a payment processing device;
a DC power source;
a DC to AC power inverter; and
an AC outlet;
wherein the central processor, upon detecting a valid payment from the payment processing device, activates the DC to AC power inverter thereby providing electricity to a power source of an electronic device via the AC outlet.

2. The system of claim 1, wherein the mobile self-contained power vending station further includes a state-of-charge sensor; and
wherein the central processor detects the state-of-charge level of the DC power source via the state-of-charge sensor.

3. The system of claim 2, wherein the mobile self-contained power vending station further includes a notification apparatus; and
wherein the central processor activates the notification apparatus, upon detecting, via the state-of-charge sensor, a lesser state-of-charge level of the DC power source than a predetermined state-of-charge level.

4. The system of claim 3, wherein the system further comprises a central data station.

5. The system of claim 4, wherein the notification apparatus comprises a wireless communications device; and
wherein the central processor activates the wireless communications device in order to transmit a notification to the central data station, upon detecting, via the state-of-charge sensor, a lesser state-of-charge level of the DC power source than a predetermined state-of-charge level.

6. The system of claim 1, wherein the mobile self-contained power vending station further includes a usage detection sensor; and
wherein the central processor detects, via the usage detection sensor, the power source of the electronic device is connected to the AC outlet.

7. The system of claim 1, wherein the AC outlet is a GFCI outlet and the electricity provided is 110 VAC.

8. The system of claim 1, wherein the mobile self-contained power vending station further includes a user Interface.

9. A system for charging a power source of an electronic device, the system comprising:
a mobile self-contained power vending station including:
a central processor;
a payment processing device;
a wireless communications device;
a DC power source;
a state-of-charge sensor;
a usage detection sensor;
a DC to AC power inverter;
an AC outlet;
a user interface;
a central data station including a communications device;
wherein the central processor, upon detecting a valid payment from the payment processing device and upon detecting, via the usage detection sensor, a power source of an electronic device is connected to the AC outlet, activates the DC to AC power inverter thereby providing electricity to the power source of the electronic device; and
wherein further the central processor activates the wireless communication device in order to transmit a notification to the central data station, upon detecting, via the state-of-charge sensor, a lesser state-of-charge level of the DC power source than a predetermined state-of charge level.

10. The system of claim 9, wherein the mobile self-contained power vending station further Includes a solar panel.

11. The system of claim 9, wherein the AC outlet comprises a GFCI outlet and the electricity provided is 110 VAC.

12. A method for charging a power source of an electronic device, the method comprising:
providing a mobile self-contained power vending station including:
a central processor;
a payment processing device;
a notification apparatus;
a DC power source;
a state-of-charge sensor;
a usage detection sensor;
a DC to AC power inverter;
an AC outlet;
a user interface;
providing a central data station;
detecting a lesser state-of-charge level of the DC power source than a predetermined state-of-charge level;
disabling the payment processing device upon detection of a lesser state-of-charge level of the DC power source than the predetermined state-of-charge level; and
notifying the central data station of the lesser state-of-charge level via the notification apparatus.

13. The method of claim of 12, the method further comprising:
upon notification, replacing the mobile self-contained power vending station with a second mobile self-contained power vending station including a DC power source comprising a higher state-of charge level than the predetermined state-of-charge level.

14. The method of claim 12, the method further comprising:
upon notification, replacing the DC power source with a second DC power source composing a higher state-of-charge level than the predetermined state-of-charge level.

15. The method of claim 12, wherein the AC outlet comprises a GFCI outlet and the electricity provided is 110 VAC.

16. The method of claim 12, wherein the mobile self-contained power vending station further includes a solar panel.

17. A method for charging a power source of an electronic device, the method comprising:
providing a mobile self-contained power vending station including:
a central processor;
a payment processing device:
a wireless communications device;
a DC power source;
a state-of-charge sensor;
a usage detection sensor;
a DC to AC power inverter;
at least one GFCI outlet;
a user interface;
providing a central data station;
determining a higher state-of-charge level of the DC power source than a predetermined state-of-charge level;
accepting payment from a user;
determining validity of payment;
determining a charging time period;
displaying instructions on the user interface for the user to select the at least one GFCI outlet;
displaying instructions on the user interface for the user to connect a power source of an electronic device to the at least one GFCI outlet;
detecting the power source of the electronic device is connected to the at least one GFCI outlet;
activating the DC to AC power inverter;
displaying the charging time period on the user interface;
activating the at least one GFCI outlet for the duration of the charging time period;
displaying the remaining charging time period on the user interface;
determining power consumption of the electronic device;
displaying instructions on the user interface for the user to insert additional payment;
deactivating the at least one GFCI outlet at the end of the charging time period;
deactivating the DC to AC power inverter; and
displaying a notice on the user interface signifying a complete charging period.

18. The method of claim 17, further comprising:
detecting a lesser state-of-charge level of the DC power source than a predetermined state-of-charge level;
disabling the payment processing device upon detection of a lesser state-of-charge level of the DC power source than the predetermined state-of charge level; and
notifying the central data station of the lesser state-of-charge level via the wireless communication device.

19. The method of claim 18, further comprising:
upon notification, replacing the mobile self-contained power vending station with a second mobile self-contained power vending station including a DC power source comprising a higher state-of charge level than the predetermined state-of-charge level.

20. The method of claim 18, further comprising:
upon notification, replacing the DC power source with a second DC power source comprising a higher state-of-charge level than the predetermined state-of-charge level.
